(19) United States
(12) Patent Application Publication
(10) Pub. No.: US 2006/0060542 A1
(43) Pub. Date: Mar. 23, 2006

(54) Reduced calcification in water heater system

(76) Inventors: Tobias Sienel, EastHampton, MA (US); Nicolas Pondicq-Cassou, Lyon (FR)

Correspondence Address: CARLSON, GASKEY & OLDS, P.C., 400 WEST MAPLE ROAD, SUITE 350, BIRMINGHAM, MI, 48009, US

(21) Appl. No.: 10/944,207

(22) Filed: Sep. 17, 2004

(51) Int. Cl. C02F 5/00

(52) U.S. Cl. 210/774; 210/175; 210/181

(57) ABSTRACT

A hot water heating system is utilized in conjunction with a refrigerant cycle such that the water is heated in an indoor heat exchanger associated with the refrigerant cycle. Water is delivered from a water source by a pump into a first heat exchanger. A refrigerant is compressed by a compressor and also delivered into the first heat exchanger. The hot refrigerant heats the water as desired by a user of the hot water system. A water softening device softens the water passing through the heat exchanger, such that calcification does not occur. Calcification is the build-up of scale by calcium leaving solution with the water and depositing itself onto hot surfaces, such as the heat exchanger surfaces. By providing the water softening device, the problem with calcification is largely eliminated such that the efficiency of the heat exchanger will be greatly increased.

### BACKGROUND OF THE INVENTION

This application relates to a hot water heating system wherein a heat exchanger is utilized in connection with a refrigerant cycle to heat water. The water utilized to be heated often contains a high percentage of minerals, and in particular calcium. The present invention incorporates a water softening element into a water circuit to reduce calcification, or the build-up of a layer of scale in the heat exchanger.

Refrigerant cycles are utilized for a variety of purposes. In a standard refrigerant cycle, a compressor compresses a refrigerant and delivers that refrigerant to a downstream heat exchanger. If the downstream heat exchanger is an indoor heat exchanger, then this heat exchanger is utilized to heat another fluid. From the indoor heat exchanger, the refrigerant passes to an expansion device, and then to an outdoor heat exchanger. It is desirable to maximize the efficiency of the heat transfer process at each of the heat exchangers in a refrigerant cycle.

Typically, a hot water heating system incorporates a burner within a hot water tank. That is, a direct heat source is utilized to generate heat to heat water. More recently, the assignee of the present invention has developed a system wherein a refrigerant cycle is utilized to pass a heated refrigerant through a heat exchanger, and heat the hot water.

There are various challenges that are raised by this new system. Since the water that is to be heated will contain a high percentage of minerals, and in particular calcium, the calcium may drop out of solution with the water when exposed to a hot surface. As an example, as the water passes over the heat exchanger coils and is heated, the calcium may drop out of solution with the water and form a layer of scale on the heat transfer surfaces. This process known as calcification, has an adverse effect on heat transfer efficiency.

### SUMMARY OF THE INVENTION

In a disclosed embodiment of this invention, a refrigerant cycle is utilized to heat a hot water supply at a heat exchanger. A water softener is incorporated into a water circuit, at a location where it will reduce calcification in the heat exchanger.

In various embodiments, any known water softening method can be utilized. As an example, electronic water softeners, electronic water conditioners, permanent magnets, electromagnets, and any other way of softening the water.

Preferably, the water softening element may be located either in or upstream of the heat exchanger. In particular, the water softening element may be located in the heat exchanger, directly upstream of the heat exchanger, in a pump utilized to drive the fluid through the heat exchanger, or upstream of the pump.

These and other features of the present invention can be best understood from the following specification and drawing, the following of which is a brief description.

### BRIEF DESCRIPTION OF THE DRAWING

FIG. 1 schematically shows a hot water heating system according to the present invention.

### DETAILED DESCRIPTION OF THE PREFERRED EMBODIMENT

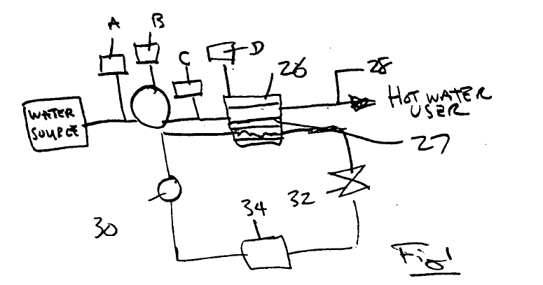

A system 20 is illustrated in FIG. 1 for heating a water supply to be utilized by a consumer. A refrigerant cycle 21 heats hot water from a water source 22.

A pump 24 drives water from the water source 22 through an indoor heat exchanger 26. The heated water is delivered to a downstream use 28. As an example, the downstream use may be a hot water storage tank which allows a consumer to request hot water as needed.

As known, the refrigerant cycle 21 incorporates a compressor 30 that compresses a refrigerant and delivers it to the heat exchanger 26. Downstream of the heat exchanger 26 is an expansion device 32, and downstream of the expansion device 32 is an outdoor heat exchanger 34. The refrigerant cycle works to first compress the refrigerant at compressor 30, and deliver this hot compressed refrigerant into the heat exchanger 26. At the heat exchanger 26, the water driven by the pump 24 is heated. The refrigerant then passes to the expansion device 32 at which it expands. From the expansion device 32, the refrigerant is delivered to the outdoor heat exchanger 34, at which it takes in heat from the environment. The refrigerant then returns to the compressor 30. The refrigerant used in the refrigerant cycle 21 may be CO2 and the refrigerant cycle 21 may be run as a transcritical cycle.

As shown, a water softening device A is incorporated into the hot water supply portion of the system 20. Water softening devices are known, and prevent the calcification as described above. Water softening device A is shown upstream of the pump 24. Alternative locations for the water softening system are shown at B, C, and D.

As mentioned above, any type of water softening device such as electronic water softeners, electronic water conditions, permanent magnets, electromagnets, and others may be utilized. Essentially, the minerals, such as calcium, are removed by the water softener prior to the water reaching the heat exchanger 26. Thus, the calcification that previously occurred on heat exchanger surfaces, such as surface 27, shown schematically, is reduced or even eliminated.

The present invention thus reduces calcification in the heat exchanger 26 such that the heat exchanger 26 will operate more efficiently over time.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A hot water heating system comprising:
a water pump for delivering water from a water source through a first heat exchanger, hot water moving from said first heat exchanger to a downstream use;
a water softening device mounted to provide a water softening function on the water passing through said first heat exchanger; and
a refrigerant cycle including a compressor for delivering a compressed refrigerant into said first heat exchanger.

2. The system as set forth in claim 1, wherein said water softening device is positioned in said first heat exchanger.

3. The system as set forth in claim 1, wherein said water softening device is positioned upstream of said first heat exchanger.

4. The system as set forth in claim 3, wherein said water softening device is positioned downstream of said pump.

5. The system as set forth in claim 3, wherein said water softening device is positioned in said pump.

6. The system as set forth in claim 3, wherein said water softening device is positioned upstream of said pump.

7. The system as set forth in claim 1, wherein said refrigerant that is compressed by said compressor is a C02.

8. The system as set forth in claim 1, wherein said refrigerant cycle is a transcritical refrigerant cycle.

9. A method of operating a hot water heating system comprising the steps of:
(1) providing a pump for delivering water from a source of water through a first heat exchanger, and delivering water heated in said first heat exchanger to a downstream user;
(2) compressing refrigerant and delivering said compressed refrigerant into said first heat exchanger to heat said water at said first heat exchanger; and
(3) providing a water softening device such that the water passing through said first heat exchanger is subjected to said water softening device.
